(19) United States
(12) Patent Application Publication
(10) Pub. No.: US 2010/0294839 A1
(43) Pub. Date: Nov. 25, 2010

(54) OPTICAL CODE SCANNER WITH AUTOMATIC FOCUSING

(75) Inventors: Yasutake Kawashima, Saitama Pref. (JP); Tohru Takahashi, Kawaguchi-shi (JP)

Correspondence Address: Kaplan Gilman & Pergament LLP, 1480 Route 9 North, Woodbridge, NJ, 07095, US

(73) Assignees: Optoelectronics Co., Ltd., Warabi (JP); Opticon, Inc., Orangeburg, NY (US)

(21) Appl. No.: 12/749,958

(22) Filed: Mar. 30, 2010

Related U.S. Application Data
(63) Continuation of application No. PCT/US07/84043, filed on Nov. 8, 2007.

(51) Int. Cl. G06K 7/14

(52) U.S. Cl. 235/455; 235/462.24

(57) ABSTRACT

A code scanner, which illuminates a scanned code from a distance, includes a liquid lens which focuses the reflected image of the code on an image sensor. The scanner includes a range detector, preferably laser-based, which determines the distance to the scanned code, and the liquid lens is controlled to focus at the detected distance. A source of illumination is uncontrolled to maintain its intensity substantially constant, regardless of the distance of the scanned code. This can be achieved by controlling the intensity of illumination (directly), or the dispersal angle of illumination in relationship to the distance.

### BACKGROUND ART

The present convention relates generally to autofocus scanning systems and, more particularly, concerns code scanners capable of reading effectively over a wide range distances from a near field to a far field.

Optical scanning systems find wide application throughout industry. Barcode scanners are a common form of code scanner. Some scanners of this type are handheld and need to recognize codes on labels in a large range of sizes over a large range of distances. For example, a barcode reader should, ideally, to be able to read anything from a tiny label with a resolution of 0.127 mm at a distance of 50 mm (near field) to a huge label with a resolution of 1.4 mm at a distance of 3 m (far field). Some scanners need to recognize two-dimensional codes, which presents an even more stringent requirement.

The fundamental problem is that the scanning system must retain sharp focus over a large depth of field (DOF), the distance, included in the near to far fields. The effective DOF can be increased by a using an automatic focus or zoom focus mechanism, such as one having a voice coil motor, to operate the optics or, the like. However, they tend to have a relatively slow response, often involve the use of moving parts (reliability issue), and they can have a relatively limited focal range. They are also not easily retrofitted into existing systems, since they must be introduced in the middle of the optics, requiring redesign of all the lenses.

Even if the shortcomings of autofocus mechanisms could be overcome, the achievement of an ideal DOF could not be achieved. Illumination for reading the code is provided by the scanner, and it falls off steeply with distance. Thus, an illumination which is barely sufficient in the far field would be much too bright in the near field.

Broadly, it is an object of the present invention to provide an optical code scanner which is capable of detecting a code image effectively over all distances from a near field to a far field.

It is another object of the present invention to provide an optical code scanner which is capable of detecting a code image a relatively quickly, preferably in 20 ms, or less.

It is another object of the present invention to provide an optical code scanner which avoids the use of moving parts, eliminating the associated reliability issues.

It is another object of the present invention to provide an optical code scanner which has a substantially greater focus range than available optical code scanners.

It is another object of the present invention to provide an optical code scanner which is easily retrofitted into existing scanning systems.

It is also an object of the present invention to provide an optical code scanner which is convenient and reliable in use, yet relatively simple and inexpensive in construction.

### DISCLOSURE OF INVENTION

In accordance with one aspect of the present invention, a code scanner, which illuminates a scanned code from a distance, includes a liquid lens which focuses the reflected image of the code on an image sensor. The scanner includes a range detector, preferably laser-based, which determines the distance to the scanned code, and the liquid lens is controlled to focus at the detected distance.

In accordance with another aspect of the invention, a code scanner, which illuminates a scanned code from a distance includes a range detector, preferably laser-based, which determines the distance to the scanned code, and the source of illumination is uncontrolled to maintain its intensity substantially constant, regardless of the distance of the scanned code. This can be achieved by controlling the intensity of illumination (directly), or the dispersal angle of illumination in relationship to the distance.

### BRIEF DESCRIPTION OF DRAWINGS

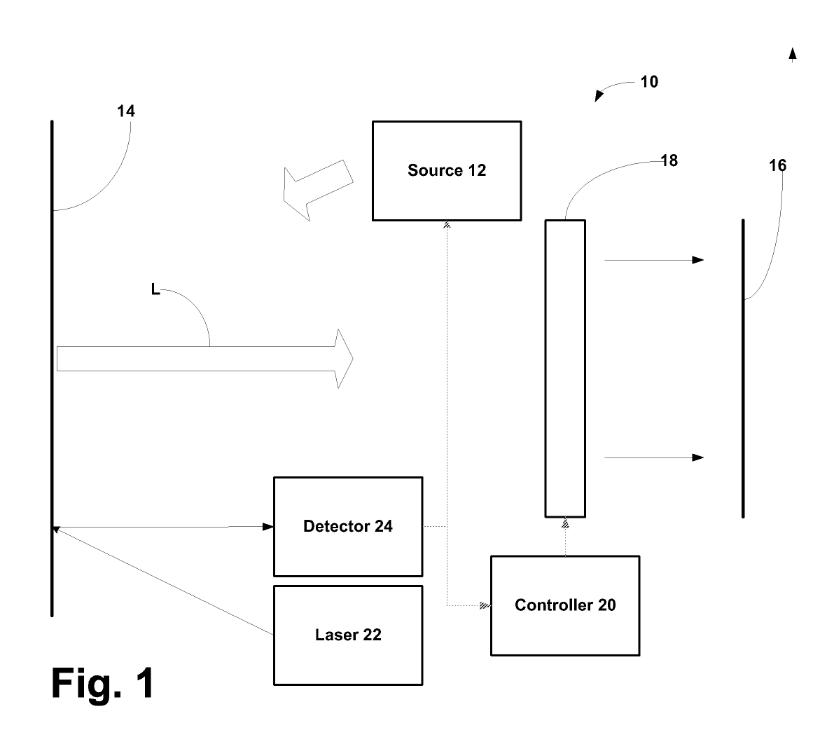

The foregoing brief description, and other objects, features and advantages of the present invention will be understood more completely from the following detailed description of presently preferred, but nonetheless illustrative, embodiments in accordance with the present invention, with reference being had to the accompanying drawings, in which FIG. 1 is schematic diagram illustrating a code scanner embodying the present invention.

### BEST MODE OF CARRYING OUT THE INVENTION

Turning now to the details of the drawings, FIG. 1 is schematic diagram illustrating a code scanner 10 embodying the present invention. The scanner 10 has a light source 12, which illuminates an optical code 14, such as a barcode, at a distance. The light L reflected from barcode 14 forms an image on image sensor 16, which is processed to decode the bar code 14.

A liquid lens 18 is interposed in the light path L between bar code 14 and image sensor 16. Those skilled in the art will understand that this an electro optical type of device which has a optical interface between two transparent layers. Through the adjustment of an applied voltage, the shape of that interface maybe changed, changing the focal length of the lens. The distance between the lens 18 and image sensor 16 remains fixed, however, the distance to the left of lens 18 of the plain on which the lens will focus will vary with the applied voltage. It is therefore possible to focus barcodes 14 at a range of distances from image sensors 16 by simply varying a voltage that controller 20 applies to lens 18. Mechanical movement of the lens is not necessary. However, it will be appreciated that the control voltage applied to lens 18 must be correlated to the actual distance of barcode 14 from lens 18 and, therefore, from image sensor 16.

In order to ensure appropriate control of lens 18, a ranging apparatus is provided which preferably comprises a laser device and a laser detector 24. Two types of laser ranging technology are well known in the art. Pulsing technology measures the delay time between the initiation of a laser pulse and the return of its reflection. Parallax technology projects a light beam to form a spot on a target and then measures the position of the detected spot on the target. The distance of the target can be determined from the position of the detected spot. Preferably, laser device 22 and detector 24 define a parallax ranging subsystem. Laser 22 projects a light beam onto bar code 14 and detector 24 senses the position of the resulting dot and determines the distances of bar code 14. It then produces a signal representative of that distance, which is applied to controller 20. In response, controller 20 is then able to apply a voltage to lens 18 to focus it appropriately.

The output signal of detector 24 is also applied to light source 12, the intensity of which is controlled accordingly. In its simplest form, source 12 could be a ray of light emitting diodes, and the intensity could be controlled by the numbers of diodes on the array that are turned on (more simply by changing optical output power). The intensity of light source 12 could also be controlled by varying the dispersion angle of the light at the midst. Those skilled in the art will appreciate that that could be achieved mechanically by controlling the angle of vain-like devices or the like, or it can be achieved optically with a condensing lens. It would be possible to provide a plurality of condensing lens and select among them or to provide a zooming lens, possibly even a liquid lens.

In any event, through the controller focus distance and light source illumination in relationship to the distance of the bar code, it becomes possible to achieve DOF performance which approaches the ideal.

Preferably, liquid lens 18 is ARCTIC-414 or ARCTIC-416 produced by Varioptic. However, other liquid lenses may be utilized as well.

In a preferred arrangement, the laser is mounted atop of the camera module, instead of at the sides or on the bottom. Additionally, the laser should be offset from the optical axis by an amount equal to 6-15 mm. Moreover, if a LEDs are used for illumination, they should be mounted on the opposite of the module from the laser, in order to minimize the effects of reflection.

As indicated previously the present invention exhibits advantages over the prior art in that it is capable of focusing a code image more quickly; in that it avoids the use of moving parts, eliminating the associated reliability issues; in that it has a substantially greater focus range; and in that it is easily retrofitted into existing scanning systems.

Although a preferred embodiment of the invention has been disclosed for a illustrative purposes, those skilled in the art will appreciate that many additions, modifications, and substitutions are possible without departing from the scope and spirit of the invention as defined by the accompanying claims.

What is claimed:

1. A scanner for imaging a remote optical code comprising:
an image sensor receiving an image of the code made up of light reflected therefrom;
a liquid lens interposed between the code and the image sensor creating the image on the sensor and having a control input for a signal which controls focus of the lens;
a range detector producing a range signal related to the distance of the optical code, a signal being applied to the control input of the lens which is related to the range signal.

2. The scanner of claim 1 wherein the range detector comprises a laser radiator projecting a beam onto the optical code to create a spot thereon and a laser detector sensing a reflection from the spot and determining the distance of the optical code.

3. The scanner of claim 2, wherein the sensor responds to the sensed position of the spot.

4. The scanner of claim 1 further comprising a source of illumination directed towards the optical code and a controller constructed to control the illumination in relationship to the range signal.

5. The scanner of claim 4 wherein the controller is constructed to control the intensity of illumination in relationship to the range signal.

6. The scanner of claim 4 wherein the controller is constructed to control the angle of disbursement of illumination in relationship to the range signal.

7. The scanner of claim 4 wherein the range detector comprises a laser radiator projecting a beam onto the optical code to create a spot thereon and a laser detector sensing a reflection from the spot and determining the distance of the optical code.

8. The scanner of claim 7, wherein the sensor responds to the sensed position of the spot.

9. A scanner for imaging a remote optical code comprising:
an image sensor receiving an image of the code made up of light reflected therefrom;
optics interposed between the code and the image sensor creating the image on the sensor;
a range detector producing a range signal related to the distance of the optical code;
a source of illumination directed towards the optical code; and
a controller constructed to control the illumination in relationship to the range signal.

10. The scanner of claim 9 wherein the range detector comprises a laser radiator projecting a beam onto the optical code to create a spot thereon and a laser detector sensing a reflection from the spot and determining the distance of the optical code.

11. The scanner of claim 10, wherein the sensor responds to the sensed position of the spot.

12. The scanner of claim 10 wherein the controller is constructed to control the intensity of illumination in relationship to the range signal.

13. The scanner of claim 10 wherein the controller is constructed to control the angle of disbursement of illumination in relationship to the range signal.

14. The scanner of claim 9 wherein the controller is constructed to control the intensity of illumination in relationship to the range signal.

15. The scanner of claim 9 wherein the controller is constructed to control the angle of disbursement of illumination in relationship to the range signal.
